(19) United States
(12) Patent Application Publication
(10) Pub. No.: US 2024/0289166 A1
(43) Pub. Date: Aug. 29, 2024

(54) METHOD AND APPARATUS FOR DEPLOYING FEDERATED LEARNING TASK BASED ON CONTAINER

(71) Applicant: Alipay (Hangzhou) Information Technology Co., Ltd., Hangzhou (CN)

(72) Inventors: Yufei LU, Hangzhou (CN); Xingyu CHEN, Hangzhou (CN); Lei WANG, Hangzhou (CN); Li WANG, Hangzhou (CN)

(21) Appl. No.: 18/571,428

(22) PCT Filed: Jul. 12, 2022
(86) PCT No.: PCT/CN2022/105250

§ 371 Date: Dec. 18, 2023

(30) Foreign Application Priority Data
Aug. 23, 2021 (CN) 202110968564.4

(51) Int. Cl. G06F 9/48

(52) U.S. Cl. CPC G06F 9/4881

(57) ABSTRACT

Embodiments of this specification provide a method and an apparatus for deploying a federated learning task based on a container. In the method, a federated learning task is deployed to a plurality of service party devices by using a container management platform, and the federated learning task is executed by using the plurality of service party devices. In the method, when receiving a task description file for the federated learning task, the container management platform can respectively generate first container group description files for the plurality of service party devices based on the task description file, and respectively send the plurality of generated first container group description files to the corresponding service party devices. The plurality of service party devices create container groups based on the respectively received first container group description files, and execute the federated learning task by using the created container groups.

This specification claims priority to Chinese Patent Application No. 2021109685644, filed with the China National Intellectual Property Administration on Aug. 23, 2021 and entitled “METHOD AND APPARATUS FOR DEPLOYING FEDERATED LEARNING TASK BASED ON CONTAINER”, which is incorporated herein by reference in its entirety.

### TECHNICAL FIELD

One or more embodiments of this specification relate to the field of computer technologies, and in particular, to a method and an apparatus for deploying a federated learning task based on a container.

### BACKGROUND

Federated learning can fully use data and computing capabilities of participants, so that a plurality of parties can collaboratively build a more robust and effective machine learning model without sharing data. In an increasingly strict environment for data supervision, federated learning can resolve key problems such as data ownership, data privacy, data access rights, and access to heterogeneous data, and has been currently applied to many industries. Better technical support is needed to implement federated learning.

Kubernetes (K8s) is an open-source system for automating deployment, scaling, and management of containerized applications. A container management platform (briefly referred to as a K8s platform) to which a K8s environment is applied can be configured to manage containerized applications on a plurality of hosts. A computing task can be executed in a container, and the container can isolate an internal environment from an external environment, so that an execution process of the task is not affected by the external environment. A container deployment capability of K8s needs to be further developed and used.

Therefore, it is expected that there can be an improved solution in which a container technology can be used to improve a deployment capability of federated learning, so that it is easier to execute a federated learning task.

### SUMMARY

One or more embodiments of this specification describe a method and an apparatus for deploying a federated learning task based on a container. A container technology can be combined with federated learning, to improve a deployment capability of federated learning, so that it is easier to execute a federated learning task. Specific technical solutions are as follows:

According to a first aspect, an embodiment provides a method for deploying a federated learning task based on a container. A federated learning task is deployed to a plurality of service party devices by using a container management platform. The federated learning task is executed by using the plurality of service party devices. The method is performed by using the container management platform and includes:
receiving a task description file for the federated learning task, where the task description file includes the plurality of service party devices and first configuration information;
respectively generating first container group description files for the plurality of service party devices based on the task description file, where the first container group description files respectively include second configuration information for the corresponding service party devices; and
respectively sending the plurality of generated first container group description files to the corresponding service party devices, so that the plurality of service party devices create container groups based on the respective first container group description files, and execute the federated learning task by using the created container groups.

In an implementation, the step of receiving a task description file for the federated learning task includes:
receiving the task description file obtained based on an input operation performed by a user.

In an implementation, the federated learning task is executed by using a server and the plurality of service party devices; the container management platform is configured to deploy the federated learning task to the server and the plurality of service party devices; the task description file further includes the server, and the first configuration information further includes configuration information related to the server; and after the receiving a task description file for the federated learning task, the method further includes:
generating a second container group description file for the server based on the task description file, where the second container group description file includes third configuration information for the server; and
sending the generated second container group description file to the server, so that the server creates a container group based on the second container group description file, and executes the federated learning task by using the created container group.

In an implementation, the step of respectively generating first container group description files for the plurality of service party devices includes:
for any service party device, determining, from the task description file, an interaction device that interacts with the service party device in the federated learning task, and second configuration information for the service party device; and
generating a first container group description file for the service party device based on the determined interaction device and the determined second configuration information for the service party device.

In an implementation, the step of generating first container group description files for the service party devices includes:
setting a restart field in the first container group description file to “Always”, where the restart field is used to indicate whether to perform a container group restart operation when a container group restart condition is met.

In an implementation, the step of generating a second container group description file for the server includes:
determining, from the task description file, an interaction device that interacts with the server in the federated learning task, and the third configuration information for the server; and
generating the second container group description file based on the determined interaction device and the determined third configuration information for the server.

In an implementation, the step of generating the second container group description file includes:
setting a restart field in the second container group description file to “Never”, where the restart field is used to indicate whether to perform a container group restart operation when a container group restart condition is met.

In an implementation, the configuration information includes executable file information and image file information; executable file information in the third configuration information is different from executable file information in the second configuration information; and image file information in the third configuration information is the same as or different from image file information in the second configuration information.

In an implementation, after the respectively sending the plurality of generated container group description files to the corresponding server and service party devices, the method further includes:
obtaining a container group running status of the server;
determining, based on the container group running status of the server, whether the federated learning task is completed; and
when determining that the federated learning task is completed, deleting, by communicating with the plurality of service party devices, the container groups that are in the plurality of service party devices and that are used to run the federated learning task.

According to a second aspect, an embodiment provides a method for deploying a federated learning task based on a container. A federated learning task is deployed to a plurality of service party devices by using a container management platform. The federated learning task is executed by using the plurality of service party devices. The method is performed by using any service party device and includes:
receiving a first container group description file sent by the container management platform, where the first container group description file includes second configuration information for the service party device, the first container group description file is generated based on a task description file for the federated learning task, and the task description file includes the plurality of service party devices and first configuration information; and
creating a container group based on the first container group description file, and running the created container group to execute the federated learning task.

In an implementation, the step of running the created container group includes:
obtaining an image file for the federated learning task; and
running the image file for the federated learning task in the created container group based on the second configuration information, and interacting with an interaction device indicated in the first container group description file, to execute the federated learning task.

In an implementation, the method further includes:
receiving a deletion message that is sent by the container management platform and that indicates to delete the container group, and deleting the container group.

According to a third aspect, an embodiment provides a method for deploying a federated learning task based on a container. A federated learning task is deployed to a server and a plurality of service party devices by using a container management platform. The federated learning task is executed by using the server and the plurality of service party devices. The method is performed by using the server and includes:
receiving a second container group description file sent by the container management platform, where the second container group description file includes third configuration information for the server, the second container group description file is generated based on a task description file for the federated learning task, and the task description file includes the server, the plurality of service party devices, and first configuration information; and
creating a container group based on the second container group description file, and running the created container group to execute the federated learning task.

In an implementation, the step of running the created container group includes:
obtaining an image file for the federated learning task; and
running the image file for the federated learning task in the created container group based on the third configuration information, and interacting with an interaction device indicated in the second container group description file, to execute the federated learning task.

In an implementation, the method further includes:
when determining that execution of the federated learning task is completed, exiting the container group, and sending a running status indicating that the container group in the server is successfully exited to the container management platform.

According to a fourth aspect, an embodiment provides a method for deploying a federated learning task based on a container. A federated learning task is deployed to a plurality of service party devices by using a container management platform. The federated learning task is executed by using the plurality of service party devices. The method includes:

The container management platform receives a task description file for the federated learning task, where the task description file includes the plurality of service party devices and first configuration information; respectively generates first container group description files for the plurality of service party devices based on the task description file, where the first container group description files respectively include second configuration information for the corresponding service party devices; and respectively sends the plurality of generated first container group description files to the corresponding service party devices; and
any service party device receives the first container group description file sent by the container management platform, creates a container group based on the first container group description file, and runs the created container group to execute the federated learning task.

According to a fifth aspect, an embodiment provides a container management platform, configured to deploy a federated learning task to a plurality of service party devices. The federated learning task is executed by using the plurality of service party devices. The container management platform includes a manager and a controller.

The manager is configured to receive a task description file for the federated learning task, and send the task description file to the controller. The task description file includes the plurality of service party devices and first configuration information.

The controller is configured to respectively generate first container group description files for the plurality of service party devices based on the task description file, and send the first container group description files to the manager. The first container group description files include second configuration information for the corresponding service party devices.

The manager is configured to respectively send the plurality of received first container group description files to the corresponding service party devices, so that the plurality of service party devices create container groups based on the respective first container group description files, and execute the federated learning task by using the created container groups.

In an implementation, the federated learning task is executed by using a server and the plurality of service party devices; the container management platform is configured to deploy the federated learning task to the server and the plurality of service party devices; and the task description file further includes the server, and the first configuration information further includes configuration information related to the server;
the controller is further configured to generate a second container group description file for the server based on the task description file, and send the second container group description file to the manager, where the second container group description file includes third configuration information for the server; and
the manager is further configured to send the received second container group description file to the server, so that the server creates a container group based on the second container group description file, and executes the federated learning task by using the created container group.

In an implementation, the manager is further configured to receive a container group running status sent by the server;
the controller is further configured to obtain a container running status of the server from the manager, and determine, based on the container running status of the server, whether the federated learning task is completed; and send a deletion message to the manager when determining that the federated learning task is completed, where the deletion message is used to indicate to delete the container groups that are in the plurality of service party devices and that are used to run the federated learning task; and
the manager is further configured to: when receiving the deletion message, delete, by communicating with the plurality of service party devices, the container groups that are in the plurality of service party devices and that are used to run the federated learning task.

According to a sixth aspect, an embodiment provides an apparatus for deploying a federated learning task based on a container. A federated learning task is deployed to a plurality of service party devices by using a container management platform. The federated learning task is executed by using the plurality of service party devices. The apparatus is deployed in any service party device and includes:
a first receiving module, configured to receive a first container group description file sent by the container management platform, where the first container group description file includes second configuration information for the service party device, the first container group description file is generated based on a task description file for the federated learning task, and the task description file includes the plurality of service party devices and first configuration information; and
a first execution module, configured to create a container group based on the first container group description file, and run the created container group to execute the federated learning task.

According to a seventh aspect, an embodiment provides an apparatus for deploying a federated learning task based on a container. A federated learning task is deployed to a server and a plurality of service party devices by using a container management platform. The federated learning task is executed by using the server and the plurality of service party devices. The apparatus is deployed in the server and includes:
a second receiving module, configured to receive a second container group description file sent by the container management platform, where the second container group description file includes third configuration information for the server, the second container group description file is generated based on a task description file for the federated learning task, and the task description file includes the server, the plurality of service party devices, and first configuration information; and
a second execution module, configured to create a container group based on the second container group description file, and run the created container group to execute the federated learning task.

According to an eighth aspect, an embodiment provides a system for deploying a federated learning task based on a container, including a container management platform and a plurality of service party devices. The system deploys a federated learning task to the plurality of service party devices by using the container management platform. The federated learning task is executed by using the plurality of service party devices.

The container management platform is configured to receive a task description file for the federated learning task, where the task description file includes the plurality of service party devices and first configuration information; respectively generate first container group description files for the plurality of service party devices based on the task description file, where the first container group description files respectively include second configuration information for the corresponding service party devices; and respectively send the plurality of generated first container group description files to the corresponding service party devices.

Any service party device is configured to receive the first container group description file sent by the container management platform, create a container group based on the first container group description file, and run the created container group to execute the federated learning task.

According to a ninth aspect, an embodiment provides a computer-readable storage medium. The computer-readable storage medium stores a computer program. When the computer program is executed in a computer, the computer is enabled to perform the method according to any one of the first aspect to the fourth aspect.

According to a tenth aspect, an embodiment provides a computing device, including a memory and a processor. The memory stores executable code. When the processor executes the executable code, the method according to any one of the first aspect to the fourth aspect is implemented.

According to the method and the apparatus provided in the embodiments of this specification, the container management platform can respectively generate the first container group description files for the plurality of service party devices based on the task description file corresponding to the federated learning task, where the first container group description files respectively include the configuration information for the corresponding devices, and send the plurality of first container group description files to the corresponding service party devices. In this way, the service party devices can respectively receive the respective first container group description files, create container groups based on the respective first container group description files, and execute the federated learning task by using the created container groups. In federated learning, the service party devices need to respectively perform different processing operations and perform device interaction, and the container management platform can respectively deliver the corresponding container group description files to the service party devices, so that corresponding processing operations can be performed in the container groups in the service party devices. Therefore, in the embodiments of this specification, a container technology can be combined with federated learning, to improve a deployment capability of federated learning, so that it is easier to execute the federated learning task.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following descriptions show merely some embodiments of this specification, and a person of ordinary skill in the art can still derive other drawings from these accompanying drawings without creative efforts.

FIG. 1-1 is a schematic diagram of an implementation architecture in an embodiment disclosed in this specification;

FIG. 1-2 is a schematic diagram of an implementation architecture in another embodiment;

FIG. 2 is a schematic flowchart of a method for deploying a federated learning task based on a container according to an embodiment;

FIG. 3-1 is a schematic diagram of some content of a task description file;

FIG. 3-2 is a schematic diagram of some content of a Pod description file for a service party device C1;

FIG. 3-3 is a schematic diagram of some content of a Pod description file for a service party device C2;

FIG. 3-4 is a schematic diagram of some content of a Pod description file for a server B;

FIG. 4 is a schematic architectural diagram of executing different federated learning tasks by using K8s according to an embodiment;

FIG. 5 is another schematic flowchart of a method for deploying a federated learning task based on a container according to an embodiment;

FIG. 6 is a schematic block diagram of a container management platform according to an embodiment;

FIG. 7 is a schematic block diagram of an apparatus for deploying a federated learning task based on a container according to an embodiment;

FIG. 8 is a schematic diagram of a structure of another apparatus for deploying a federated learning task based on a container according to an embodiment; and

FIG. 9 is a schematic block diagram of a system for deploying a federated learning task based on a container according to an embodiment.

### DESCRIPTION OF EMBODIMENTS

The solutions provided in this specification are described below with reference to the accompanying drawings.

Federated learning is a machine learning technology in which training can be performed between a plurality of service party devices with local service data (samples) without a need to exchange data samples. Federated learning is characterized by participation of a plurality of devices in one task. Usually, a federated learning task includes at least two or more service party devices. In some cases, a central server can also participate in the task. Service data in the service party devices is used as samples to perform federated learning. Federated learning is to jointly train a service prediction model by using service data in a plurality of service party devices while meeting requirements such as user privacy protection and data security.

For example, it is assumed that there are two different organizations 1 and 2, and the two organizations have different data (service data). For example, the organization 1 has user feature data of a batch of users, and the organization 2 has user feature data of another batch of users. In consideration of user privacy data protection, the two organizations cannot send the respective user feature data to another device. If each organization trains a service prediction model by using the data in each organization, a high-quality model possibly cannot be obtained through training due to insufficient sample data or incomplete data. However, in federated learning, model training can be jointly performed by using service data in a plurality of organizations while privacy data security is protected, so that each party obtains a high-quality service prediction model.

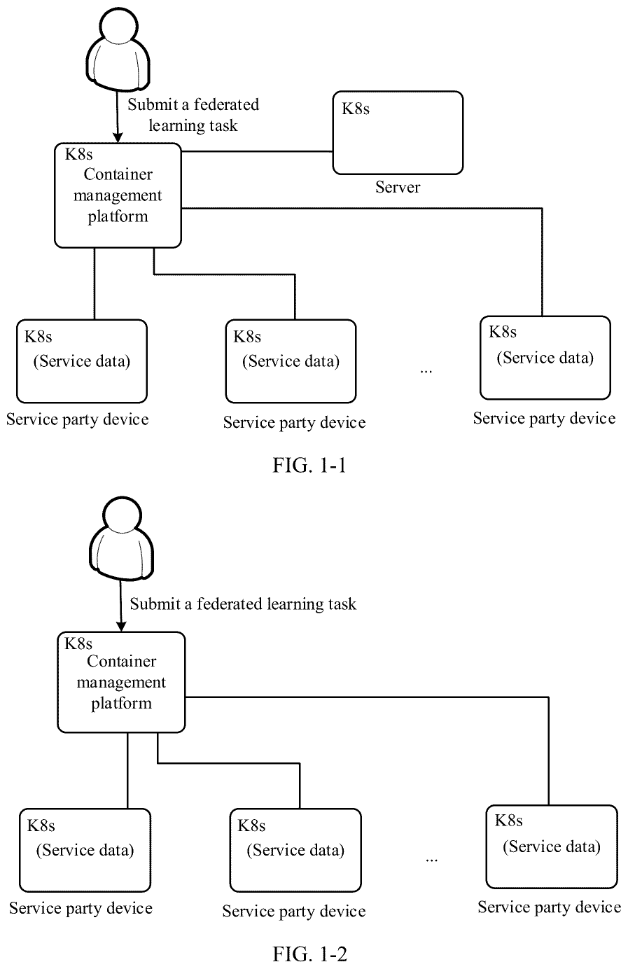

Federated learning can be performed in a plurality of implementation architectures. FIG. 1-1 is a schematic diagram of an implementation architecture in an embodiment disclosed in this specification. All of a container management platform, a server, and a plurality of service party devices are in a Kubernetes (K8s) environment. When receiving a federated learning task submitted by a user, the container management platform can deploy the federated learning task to the server and the plurality of service party devices, and execute the federated learning task by using service data in the plurality of service party devices and through interaction between the server and the plurality of service party devices. The server is a central server in federated learning, and the service party device is an edge device.

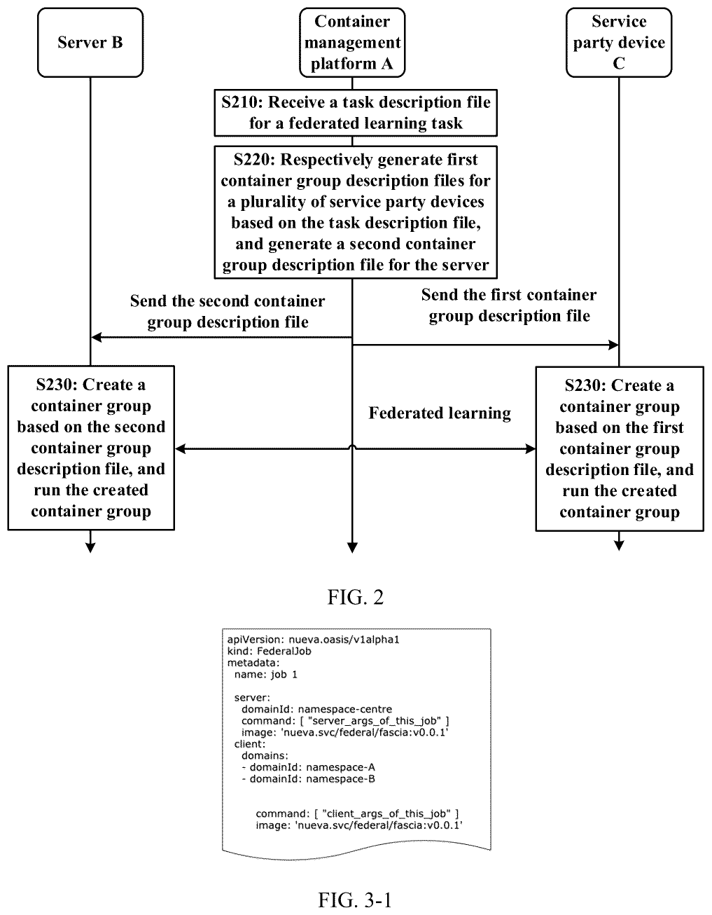

A client-server architecture that includes the server and the plurality of service party devices is a specific implementation of federated learning. In actual application, federated learning can also be implemented by using a peer-to-peer network architecture. The peer-to-peer network architecture includes a plurality of service party devices, and does not include a server. In this network architecture, federated learning is implemented between the plurality of service party devices in a preset data transmission manner. FIG. 1-2 is a schematic diagram of an implementation architecture in another embodiment. A container management platform and a plurality of service party devices are in a K8s environment. When receiving a federated learning task submitted by a user, the container management platform can deploy the federated learning task to the plurality of service party devices, and the plurality of service party devices execute the federated learning task by using respective service data and through interaction between the plurality of service party devices.

In the embodiments of this specification, in federated learning implemented in the client-server architecture, the server is used as a central device, and the service party device is used as an edge device. The service party devices train a service prediction model by using the service data in the service party devices, to obtain parameters such as gradients used to update a model parameter, and the plurality of service party devices perform privacy processing on the gradients, and then send the gradients to the server. The server aggregates the gradients obtained after privacy processing, and returns an aggregated gradient to the plurality of service party devices. The service party devices update the model parameter by using the aggregated gradient. Federated learning in this architecture includes federated learning implemented based on differential privacy. In the peer-to-peer network architecture, secure multi-party computation can be used between the plurality of service party devices based on the service data in the plurality of service party devices, so that each of the plurality of service party devices obtains a computation result of a computing layer in a service prediction model, to train the service prediction model. Federated learning in this architecture can be referred to as federated learning implemented by using secure multi-party computation. In actual application, in the foregoing two architectures, federated learning can further include many specific implementations, which are not listed one by one here.

Federated learning can be applied to many fields such as telecommunications, medical, and the Internet of Things. The service party device corresponds to an organization. Different organizations process and transmit data by using different service party devices. In different fields, the service data in the service party device has different meanings.

The service data can include object feature data of an object. For example, the object can be one of a user, a product, and a transaction. The object feature data can include at least one of the following feature groups: a basic attribute feature of the object, a historical behavior feature of the object, an association relationship feature of the object, an interaction feature of the object, a body indicator of the object, and the like. The service data is privacy data of a service party and cannot be output in a plaintext form.

The service prediction model can be used to determine a prediction result of the object by using a model parameter and the object feature data. The prediction result can be a classification result or a regression result. In different application scenarios, a prediction result of the service prediction model has different meanings. For example, in a user risk detection scenario, a prediction object can be a user, and the service prediction model is implemented as a risk detection model. The risk detection model is used to process input user feature data to obtain a prediction result indicating whether the user is a high-risk user. In this scenario, a sample feature is the user feature data, and sample labeling information is, for example, whether the user is a high-risk user. In a medical evaluation scenario, a prediction object can be a drug, drug feature data can include function information of the drug, applicable range information, related body indicator data of a patient existing before and after the drug is used, a basic attribute feature of the patient, and the like, and the service prediction model is implemented as a drug evaluation model. The drug evaluation model is used to process the input drug feature data to obtain an effect evaluation result of the drug. In this scenario, sample labeling information is, for example, a drug effective value labeled based on the related body indicator data of the patient existing before and after the drug is used.

In the embodiments of this specification, a federated learning task can be understood as follows: A process in which iterative training is performed on the service prediction model for a plurality of times by using service data of each party until the service prediction model converges is used as a federated learning task, and a process of the federated learning task is completed. For example, model training is performed on the drug evaluation model by using drug feature data in a plurality of hospitals. This can be referred to as a federated learning task. When training of the drug evaluation model is completed by performing iterative training for a plurality of times, it indicates that the federated learning task is completed. That is, the federated learning task can be understood as follows: A task of jointly training the service prediction model by using a plurality of pieces of sample data (service data) in a plurality of service party devices is a federated learning task.

Usually, the federated learning task can be initiated by a user, and the federated learning task is completed by common computers deployed in a plurality of organizations. For example, each hospital is used as a party in federated learning, and executes the federated learning task by using a common computer provided by the hospital. Information levels of organizations such as hospitals are not high enough, models of provided computer devices are not uniform, and there are various software environments. Therefore, it is difficult to meet a requirement of the federated learning task for an environment.

K8s is a container orchestration tool and an automated container operation and maintenance management program, and supports combination of a plurality of hosts into a cluster to run containerized applications. In addition, K8s can automatically create and delete containers, to eliminate many manual operations involved in deploying, scaling, and putting offline mirrored applications. The container management platform can be a device to which a K8s environment is applied and that can implement the cluster that includes a plurality of hosts to run containerized applications, and is briefly referred to as a K8s platform.

In K8s, a container group Pod is a smallest computing unit (or referred to as a scheduling unit or an orchestration unit) that can be created and managed. The container group can include one or more containers, that is, there is a single-container Pod and a multi-container Pod. The container is a carrier for running an application (task), and the application is prepackaged in an image file. Usually, one container runs one image file, and one image file can be placed in a plurality of containers to run. Currently, docker is an implementation of a container technology. When a user submits a task to the K8s platform, the K8s platform can receive a description file submitted by the user for the task. The K8s platform can automatically allocate a container group (Pod) for the description file to execute the task submitted by the user, and run a corresponding image file in the container group to execute the task. The container is responsible for isolating an internal environment from an external environment, so that an execution process of the task is not affected by the external environment, and effective privacy protection can be performed for the execution process of the task. In an implementation, the federated learning task can be executed by using a single-container Pod.

To improve applicability of federated learning and implement a federated learning process, the embodiments of this specification provide an implementation in which K8s is combined with federated learning, so that K8s can be applied to a federated learning scenario, to meet a service requirement and fully use automated container orchestration, management, operation and maintenance capabilities of K8s.

The embodiments of this specification provide a method for deploying a federated learning task based on a container. A federated learning task is deployed to a plurality of service party devices by using a container management platform. The federated learning task is executed by using at least the plurality of service party devices. In the method, the container management platform receives a task description file for the federated learning task. The task description file includes the plurality of service party devices and first configuration information. The container management platform respectively generates first container group description files for the plurality of service party devices based on the task description file. The first container group description files respectively include second configuration information for the corresponding service party devices. The container management platform respectively sends the plurality of generated first container group description files to the corresponding service party devices. The plurality of service party devices respectively receive the first container group description files sent by the container management platform, create container groups based on the respective first container group description files, and run the created container groups to execute the federated learning task. In the embodiments, container group description files for different service party devices can be generated based on the task description file, so that the service party devices perform respective data processing by using container groups, to execute the federated learning task. This implements a combination of container technology and federated learning.

In addition, a plurality of containers deployed in the plurality of devices are isolated from each other. An image file that is run in each container includes a federated learning application and all dependencies of the federated learning application, and the container runs without depending on an external library file. This decouples the container from an underlying facility and an operating system of the device, and can adapt to software and hardware environments of computers of different institutions, so that execution of a federated learning process is not affected by the different software and hardware environments of the computer devices.

With reference to a specific embodiment shown in FIG. 2, the following describes this specification by using a client-server architecture as an example.

FIG. 2 is a schematic flowchart of a method for deploying a federated learning task based on a container according to an embodiment. In this embodiment, a federated learning task Job1 is deployed to a server B and a plurality of service party devices C by using a container management platform A. The container management platform A is configured to manage container clusters in the server B and the plurality of service party devices C. The federated learning task Job1 is executed by using the server B and the plurality of service party devices C. The plurality of service party devices C can include two or more service party devices, for example, service party devices C1, C2, . . . , and Cn. Here, n is a natural number. In this embodiment, each of the container management platform A, the server B, and any service party device C can be implemented by using any apparatus, device, platform, device cluster, or the like that has a computing and processing capability. This method embodiment includes the following steps S210 to S230.

Step S210: The container management platform A receives a task description file for the federated learning task Job1.

The container management platform A can receive the task description file obtained based on an input operation performed by a user. That is, the task description file can be submitted by the user to the container management platform A. For example, the container management platform A can provide a page that includes a plurality of options to the user, so that the user selects content in a drop-down box of the page and enters information in an input box.

The container management platform A can alternatively receive the description file that is for the federated learning task Job1 and that is sent by another device. For example, the another device can be user equipment or a service party device. After obtaining the federated learning task Job1 submitted by a user, the another device can submit the corresponding task description file to the container management platform A.

The task description file includes the server B and the plurality of service party devices C that participate in the federated learning task Job1, and first configuration information.

Basic K8s software can be installed in the server B and the plurality of service party devices C, to implement interaction with the container management platform A through the basic K8s software. The server B and the plurality of service party devices C can serve as nodes in a K8s cluster, and respectively have different namespace (namespace) names. The task description file can include namespace names of the server B and the plurality of service party devices C.

The first configuration information includes executable file information and image file information. The executable file information includes a storage path of an executable file and an input parameter of the executable file. The storage path is a storage path of the executable file in an image file, and the input parameter includes a startup parameter needed to run the executable file. The image file information includes information such as an image file identifier and a category of an image file. Specifically, the first configuration information can include executable file information and image file information of the server B and executable file information and image file information of the plurality of service party devices C.

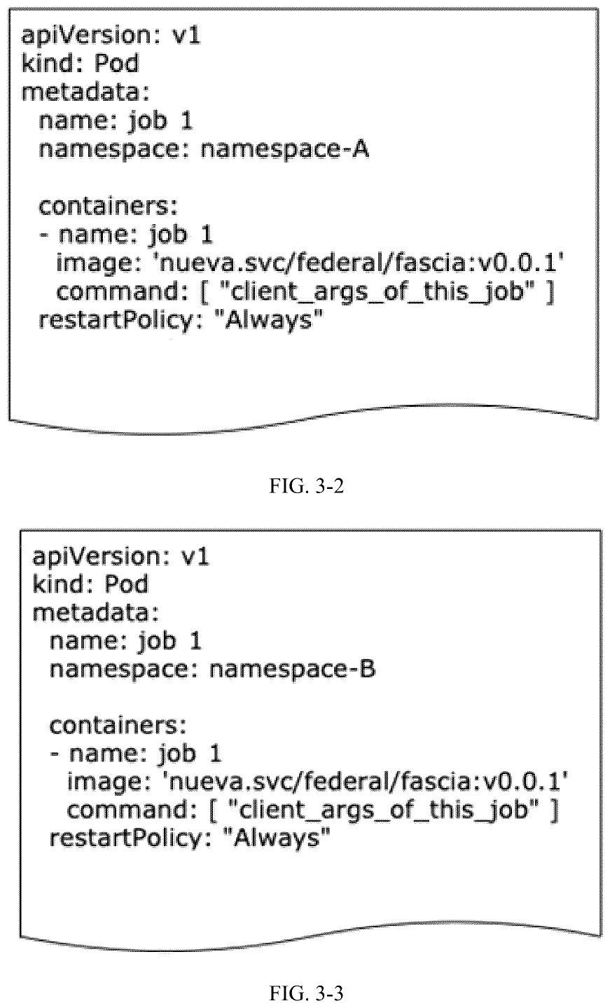

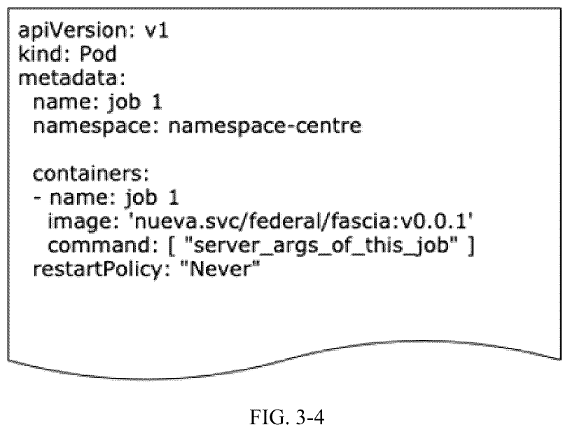

The task description file can further include information such as a name of the federated learning task Job1 and a kind and a version of the description file. In a K8s environment, the task description file can be implemented by using a file in a yaml format. FIG. 3-1 is a schematic diagram of some content of a task description file. The task description file specifies a kind of the description file (a kind field value is a federated learning task FederalJob), a task name (name field), an image file name (image field) used by the task, an executable file path (command field) of the task, and an input parameter args. The following information of the server (server) and the plurality of service party devices (client) is specifically included: a domainId field value, a command field value, and an image field value. The command field value and the input parameter args of the command field value are executable file information. In addition, the task description file can further include a large amount of other field information, for example, version information (apiVersion field) and metadata (metadata). The foregoing description is merely an example of the task description file, and does not constitute a limitation on this specification.

The server B and the plurality of service party devices C included in the task description file are devices that participate in the federated learning task Job1, and there is an interaction requirement between these devices in a federated learning process. A specific interaction process is described in the foregoing description of implementing federated learning in the client-server architecture. Details are omitted for simplicity here.

Step S220: The container management platform A respectively generates first container group description files for the plurality of service party devices C based on the task description file, and generates a second container group description file for the server B based on the task description file; and respectively sends the plurality of generated first container group description files to the corresponding service party devices C, and sends the generated second container group description file to the server B. Any service party device C receives the first container group description file sent by the container management platform A, and the server B receives the second container group description file sent by the container management platform A.

The container group description file is a description file used to create a container group and indicate the container group to run a corresponding task. The first container group description file for the any service party device C1 includes an interaction device and second configuration information for the service party device C1. The second container group description file includes an interaction device and third configuration information for the server.

For the any service party device C1, the interaction device that interacts with the service party device C1 in the federated learning task Job1 and the second configuration information for the service party device C1 can be determined from the task description file, and the first container group description file for the service party device C1 is generated based on the determined interaction device and the determined second configuration information for the service party device.

For example, the plurality of service party devices can include service party devices C1, C2, and C3. The service party device C1 is any one of the plurality of service party devices. The task description file includes the server B and the plurality of service party devices C1, C2, and C3 that participate in the federated learning task Job1. The interaction device that interacts with the service party device C1 can be determined from the server B and a plurality of other service party devices C2 and C3 based on a preset interaction rule of federated learning. For example, the interaction device that interacts with the service party device C1 is the server B, and it is determined that namespace of the server B is namespace-centre. The interaction device that interacts with the service party device C can include at least one of the server and the plurality of other service party devices. The interaction device can be determined based on the preset interaction rule of federated learning.

The second configuration information can include executable file information and image file information. When the second configuration information for the service party device C1 is determined, executable file information and image file information that are of the service party device C1 and that are included in the first configuration information can be determined as the second configuration information.

When the first container group description file for the service party device C1 is generated, the determined interaction device and the determined second configuration information can be used as field values of corresponding fields in the first container group description file.

The first container group description file can further include a restart field restartPolicy. The restart field is used to indicate whether to perform a container group restart operation when a container group restart condition is met. A field value of the restart field can include “Always” (Always) and “Never” (Never). A restart field in the first container group description file for the service party device C1 can be set to “Always”. The container group restart condition can include that a Pod crashes or a normally executed task ends. When the restart field is set to “Always”, it indicates that when a Pod crashes or a normally executed task ends, a new Pod is created and the Pod is run. When the restart field is set to “Never”, it indicates that when a Pod crashes or a normally executed task ends, no new Pod is created.

The first container group description file can further include information such as the name of the federated learning task Job1 and a kind and a version of the description file. For example, FIG. 3-2 is a schematic diagram of some content of a Pod description file for the service party device C1. A kind field value of the description file is a container group Pod, a name field value of the federated learning task Job1 is job1, a namespace field value of the service party device C1 is namespace-A, an image file name used by the task is an image field value, executable file information of the task is a command field value and an input parameter args, a field value of the restart field restartPolicy is set to “Always”, metadata is metadata information, and containers is container information. Interaction device information is not displayed in FIG. 3-2.

For different service party devices, for example, for the service party devices C1 and C2, principal content of Pod description files for the service party devices C1 and C2 can be the same. For example, for the service party devices C1 and C2, interaction devices can be the same, and second configuration information can be the same. That is, for different service party devices, interaction devices for all of the service party devices can be the server B, and executable file information and image file information can be the same. In another implementation, principal content of Pod description files for different service party devices can be different, and can be specifically determined based on a preset processing rule of federated learning. In addition to the principal content, the Pod description file can further include non-principal content (for example, metadata). For different service party devices, non-principal content of the service party devices can be different.

In an example, FIG. 3-3 is a schematic diagram of some content of a Pod description file for the service party device C2. Compared with FIG. 3-2, principal content of the Pod description files for the service party devices C1 and C2 is the same, and includes a command field value, an image field value, and a restartPolicy field value. In non-principal content, apiVersion field values, kind field values, and name field values are the same, and namespace field values are different (a namespace field value of the service party device C1 is namespace-A, and a namespace field value of the service party device C2 is namespace-B).

For the server B, when the second container group description file is generated, the interaction device that interacts with the server B in the federated learning task and the third configuration information for the server B can be determined from the task description file, and the second container group description file is generated based on the determined interaction device and the determined third configuration information for the server B.

For example, the plurality of service party devices include service party devices C1, C2, and C3. The task description file includes the server B and the plurality of service party devices C1, C2, and C3 that participate in the federated learning task Job1. The interaction device that interacts with the server B can be determined from the plurality of service party devices C1, C2, and C3 based on a preset interaction rule of federated learning. For example, the interaction device that interacts with the server B is the service party devices C1, C2, and C3. The interaction device can be determined based on the preset interaction rule of federated learning.

The third configuration information can include executable file information and image file information. When the third configuration information for the server B is determined, the executable file information and the image file information that are of the server B and that are included in the first configuration information can be determined as the third configuration information.

When the second container group description file for the server B is generated, the determined interaction device and the determined third configuration information can be used as field values of corresponding fields in the second container group description file.

The second container group description file can further include a restart field restartPolicy, and a field value of the restart field can be set to “Never” (Never). That is, when the field value of restartPolicy in the Pod description file is “Never”, if a Pod crashes or a normally executed task ends, an operation of creating a new Pod is not performed.

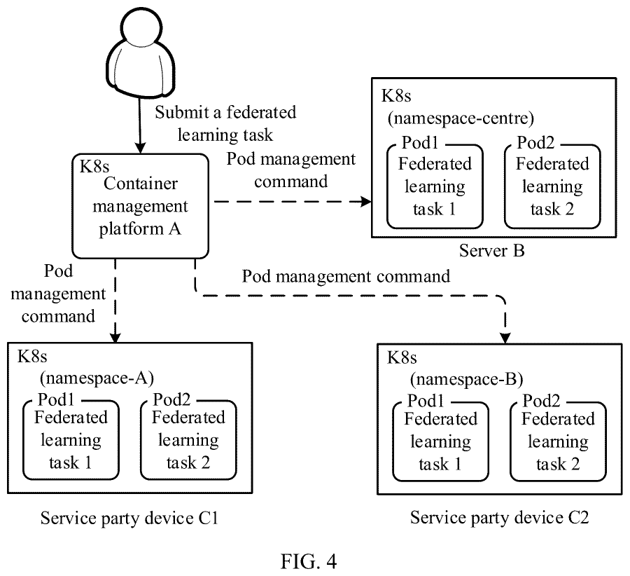

The second container group description file can further include information such as the name of the federated learning task Job1 and a kind and a version of the description file. For example, FIG. 3-4 is a schematic diagram of some content of a Pod description file for the server B. A kind field value of the description file is a container group Pod, a name field value of the federated learning task Job1 is job1, a namespace field value of the server B is namespace-centre, an image file name used by the task is an image field value, executable file information of the task is a command field value and an input parameter args, a field value of the restart field restartPolicy is set to “Never”, metadata is metadata information, and containers is container information. Interaction device information is not displayed in FIG. 3-4.

In conclusion, the configuration information (including the first configuration information, the second configuration information, and the third configuration information) includes executable file information and image file information. The executable file information in the third configuration information for the server B and the executable file information in the second configuration information for the service party device C can be different. For example, executable files can be the same, but input parameters are different. The image file information in the third configuration information and the image file information in the second configuration information can be the same or different. The information can be specifically determined based on preset federated learning configuration information.

A client end in federated learning is deployed in an organization, and a device of the organization is an edge device. Due to a limitation of a relatively poor network and device hardware execution condition of the organization, stability of the service party device C is lower than that of the server. Therefore, a Pod in the client end in federated learning is set to “reconnectable”, that is, a restart field in a Pod description file is set to “Always”. In this way, a service party device is disconnected, and a process of an entire task is not affected. When the Pod in the service party device is restarted, the server B can be connected again, to continue to execute the previous task. A device on a server end maintains the process of the entire task. Once the Pod is restarted, the entire task progress is lost. Therefore, the Pod in server B can be set not to “Never”.

The plurality of Pod description files can further include information about whether a Pod to be created is a single-container Pod or a multi-container Pod.

The container management platform A stores address information of the server B and the plurality of service party devices C. Based on the address information, the second container group description file can be sent to the server B, and the first container group description files are sent to the plurality of service party devices C.

Step S230: The any service party device C1 creates a container group based on the first container group description file, and runs the created container group; and the server B creates a container group based on the second container group description file, and runs the created container group, so that the plurality of service party devices C and the server B jointly execute the federated learning task Job1.

Each service party device can create a container group based on the first container group description file received by the service party device, and run the created container group. A specific implementation of creating and running a container group is described below by using the any service party device C1 as an example.

The service party device C1 can obtain an image file for the federated learning task Job1, run the image file for the federated learning task in the created container group based on the second configuration information for the service party device C1, and interact with the interaction device indicated in the first container group description file, to execute the federated learning task Job1.

The server B can obtain an image file for the federated learning task Job1, run the image file for the federated learning task in the created container group based on the third configuration information, and interact with the interaction device indicated in the second container group description file, to execute the federated learning task Job1.

The image file is a file that needs to be run in a container when the federated learning task Job1 is executed. The image file includes an application and all dependencies of the application. When being executed, the image file no longer depends on an external library file, and can be executed anywhere. Specifically, the image file can include meta information and a file set. The file set includes all files needed for executing the federated learning task Job1, and includes an executable file, a configuration file, and a basic library file on which running depends. That is, the file set includes a complete operating system and file system that are needed for running the federated learning task Job1. The meta information records basic information about the image file, and includes but is not limited to an image file identifier and executable file information.

For the service party device C1, an image file for the service party device C1 can be preset in the service party device C1, or can be stored in an image file library, and the image file library can be located in a dedicated storage platform. Therefore, the service party device C1 can obtain the image file from the service party device C, or can obtain the image file from the image file library based on the image file identifier in the first container group description file.

For the server B, an image file for the server B can be preset in the server B, or can be stored in an image file library. Therefore, the server B can obtain the image file from the server B, or can obtain the image file from the image file library based on an image file identifier in the second container group description file.

When receiving the Pod description files, the server B and the plurality of service party devices C in which basic K8s software is installed can automatically create and run Pods based on definitions of the Pod description files. A process of automatically creating and running a Pod based on a Pod description file by a device that has basic K8s software is a basic function of K8s. A more detailed process is not described.

In a running process of the container groups Pods in the server B and the plurality of service party devices C, running statuses of the container groups Pods in the server B and the plurality of service party devices C are fed back to the container management platform A. Therefore, the container management platform A can receive the running status of the Pod in the server B, and receive running statuses of the Pods in the plurality of service party devices C. The container management platform A can query the received Pod running status.

The container management platform A can determine, based on the Pod running status of the server, whether the federated learning task Job1 is completed. When determining that the federated learning task Job1 is completed, the container management platform A deletes, by communicating with the plurality of service party devices C, the container groups that are in the plurality of service party devices C and that are used to run the federated learning task Job1.

For example, when determining that execution of the federated learning task Job1 is completed, the server B exits the corresponding container group Pod, and sends a Pod running status indicating that the container group in the server is successfully exited to the container management platform A.

When determining that the Pod running status sent by the server B indicates that the container group in the server B is successfully exited, the container management platform A determines that the federated learning task Job1 is completed. In this case, the container management platform A can send a deletion message to the plurality of service party devices C. The deletion message is used to delete the container groups Pods that are in the service party devices C and that run the federated learning task Job1. The deletion message can carry the name of the federated learning task Job1.

When receiving the deletion message that is sent by the container management platform A and that indicates to delete the container group Pod, the any service party device C1 can delete the corresponding container group. In this way, the container group Pod running in the service party device C can be ended.

In federated learning in this embodiment, the server B and the service party devices C need to respectively perform different processing operations, and the container management platform A respectively delivers different container group description files to the server B and the service party devices C, so that different processing operations can be performed in the container groups deployed in the server B and the service party devices C. The server B and the plurality of service party devices C are uniformly deployed by using the container management platform A, and each device can quickly create a corresponding container group, to execute the federated learning task.

In addition, the container management platform A in this embodiment can disassemble a federated learning task description file that cannot be originally recognized by K8s into a Pod description file that can be recognized by K8s, so that a capability of K8s is used as much as possible. In addition, an organization end does not need to develop a new program to support federated learning. Therefore, research and development costs and complexity of an organization-end device system are simplified, and robustness of an organization-end service is increased.

The container management platform A can coordinate and control Pods in different organizations by observing running statuses of the Pods, and map a change of the running statuses of the Pods to execution of the federated learning task, so that the user can view a real-time status in an execution process of the federated learning task without perceiving details of the Pods.

The container management platform can further deploy different federated learning tasks in the server and the plurality of service party devices, for example, deploy a federated learning task 1 and a federated learning task 2. In different federated learning tasks, a service prediction model executes different prediction tasks. For example, structures of the service prediction model of the tasks can be different, and labels of samples are different. The image file can be isolated from the external environment by using the container group, and is not affected by the external environment during running. Different federated learning tasks are executed in different container groups, so that the different federated learning tasks do not affect each other in an execution process.

For example, FIG. 4 is a schematic architectural diagram of executing different federated learning tasks by using K8s according to an embodiment. All of the container management platform A, the server B, and the two service party devices C1 and C2 are in the K8s environment, and node devices respectively have the following namespace: namespace-centre, namespace-A, and namespace-B. The container management platform A can manage Pod1 and Pod2 in the server B and the service party devices C1 and C2 by using a Pod management command. Pod1 is used to execute the federated learning task 1, and Pod2 is used to execute the federated learning task 2. The Pod management command can include automatic creation of a Pod and deletion of a Pod. The Pod management command for automatically creating a Pod includes a container group description file. Each device creates and runs a Pod based on the container group description file. Here, the two service party devices C1 and C2 are used as examples. In actual application, there can be a larger quantity of service party devices.

In the foregoing description, the embodiments of this specification are described by using the client-server architecture as an example. An embodiment shown in FIG. 5 is briefly described below by using a peer-to-peer network architecture as an example. In the following description, a difference between the embodiment shown in FIG. 5 and the embodiment shown in FIG. 2 is emphatically described, a similarity is not described, and mutual references can be made between the two embodiments.

FIG. 5 is another schematic flowchart of a method for deploying a federated learning task based on a container group according to an embodiment. In the method, a federated learning task Job2 is deployed to a plurality of service party devices by using a container management platform A, and the federated learning task Job2 is executed by using the plurality of service party devices C. The method includes steps S510 and S520.

Step S510: The container management platform A receives a task description file for the federated learning task Job2, respectively generates first container group description files for the plurality of service party devices C based on the task description file, and respectively sends the plurality of generated first container group description files to the corresponding service party devices C.

The container management platform A can receive the task description file obtained based on an input operation performed by a user, or can receive the description file that is for the federated learning task Job2 and that is sent by another device.

The task description file includes the plurality of service party devices C that participate in the federated learning task Job2 and first configuration information. The first configuration information can include executable file information and image file information of the plurality of service party devices C.

For any service party device C1, an interaction device that interacts with the service party device C1 in the federated learning task Job2 and second configuration information for the service party device C1 can be determined from the task description file, and a first container group description file for the service party device C1 is generated based on the determined interaction device and the determined second configuration information for the service party device.

For example, the plurality of service party devices can include service party devices C1, C2, and C3. The service party device C1 is any one of the plurality of service party devices. The task description file includes the plurality of service party devices C1, C2, and C3 that participate in the federated learning task Job2. The interaction device that interacts with the service party device C1 can be determined from a plurality of other service party devices C2 and C3 based on a preset interaction rule of federated learning. For example, the interaction device that interacts with the service party device C1 is the service party devices C2 and C3, and namespace of the service party devices C2 and C3 is determined. The interaction device that interacts with the service party device C can include one or more of the other service party devices. The interaction device can be determined based on the preset interaction rule of federated learning.

In this embodiment, the interaction rule of federated learning can be that in the plurality of service party devices, interaction with all service party devices other than the service party devices is performed, interaction is performed in a cyclic transmission manner, or interaction is performed in a random transmission manner. This manner is not specifically limited in this embodiment.

The plurality of first container group description files respectively include second configuration information for the corresponding service party devices C. The second configuration information can include executable file information and image file information. When the second configuration information for the service party device C1 is determined, executable file information and image file information that are of the service party device C1 and that are included in the first configuration information can be determined as the second configuration information.

When the first container group description file for the service party device C1 is generated, the determined interaction device and the determined second configuration information can be used as field values of corresponding fields in the first container group description file. The first container group description file can further include a restart field restartPolicy that can be set to “Always”.

For different service party devices, for example, for the service party devices C1 and C2, principal content of container group Pod description files for the service party devices C1 and C2 can be different. For example, for the service party devices C1 and C2, interaction devices are different, and second configuration information can be the same. That is, for different service party devices, interaction devices for the service party devices are different, and executable file information and image file information can be the same. In addition to the principal content, the Pod description file can further include non-principal content (for example, metadata). For different service party devices, non-principal content of the service party devices can be different.

Step S520: The any service party device C1 receives the first container group description file sent by the container management platform A, creates a container group based on the first container group description file, and runs the created container group to execute the federated learning task Job2.

Each service party device can create a container group based on the first container group description file received by the service party device, and run the created container group. A specific implementation of creating and running a container group is described below by using the any service party device C1 as an example.

The service party device C1 can obtain an image file for the federated learning task Job2, run the image file for the federated learning task in the created container group based on the second configuration information for the service party device C1, and interact with the interaction device indicated in the first container group description file, to execute the federated learning task Job2.

In a running process of the container groups Pods in the plurality of service party devices C, running statuses of the container groups Pods in the plurality of service party devices C are fed back to the container management platform A. Therefore, the container management platform A can receive the running statuses of the Pods in the plurality of service party devices C. The container management platform A can further query the received Pod running status. The container management platform A can determine, based on the Pod running statuses of the plurality of service party devices, whether the federated learning task Job2 is completed. When determining that the federated learning task Job2 is completed, the container management platform A deletes, by communicating with the plurality of service party devices C, the container groups that are in the plurality of service party devices C and that are used to run the federated learning task Job2.

In federated learning in this embodiment, the plurality of service party devices C need to respectively perform different processing operations, and the container management platform A respectively delivers different container group description files to the plurality of service party devices C, so that different processing operations can be performed in the container groups deployed in the plurality of service party devices C. The plurality of service party devices C are uniformly deployed by using the container management platform A, and each device can quickly create a corresponding container group, to execute the federated learning task.

In this specification, “first” in the first configuration information and the first container group description file, and corresponding “second” and “third” in this specification are merely intended to facilitate distinguishing and description, and have no limitation meaning.

Specific embodiments of this specification are described above, and other embodiments fall within the scope of the appended claims. In some cases, the actions or steps described in the claims can be performed in a sequence different from that in the embodiments and desired results can still be achieved. In addition, the process depicted in the accompanying drawings does not necessarily need a particular sequence or consecutive sequence to achieve the desired results. In some implementations, multitasking and parallel processing are possible or may be advantageous.

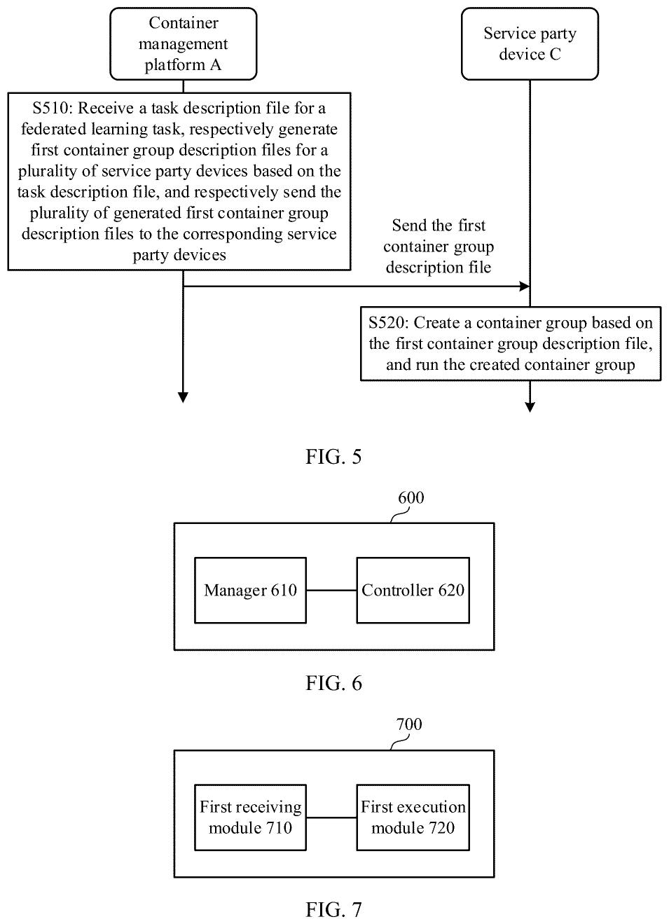

FIG. 6 is a schematic block diagram of a container management platform according to an embodiment. In this embodiment, the container management platform 600 is configured to deploy a federated learning task to a plurality of service party devices, and the federated learning task is executed by using the plurality of service party devices. The container management platform 600 includes a manager (Master) 610 and a controller (FJ-Controller) 620. This container management platform embodiment corresponds to the method embodiment shown in FIG. 2.

The manager 610 is configured to receive a task description file for the federated learning task, and send the task description file to the controller 620. The task description file includes the plurality of service party devices and first configuration information.

The controller 620 is configured to receive the task description file sent by the manager 610, respectively generate first container group description files for the plurality of service party devices based on the task description file, and send the plurality of first container group description files to the manager 610. The first container group description files include second configuration information for the corresponding service party devices.

The manager 610 is configured to receive the plurality of first container group description files sent by the controller 620, and respectively send the plurality of received first container group description files to the corresponding service party devices, so that the plurality of service party devices create container groups based on the respective first container group description files, and execute the federated learning task by using the created container groups.

In an implementation, that the manager 610 receives a task description file for the federated learning task includes:
receiving the task description file obtained based on an input operation performed by a user.

In an implementation, the federated learning task is executed by using a server and the plurality of service party devices; the container management platform is configured to deploy the federated learning task to the server and the plurality of service party devices; and the task description file further includes the server, and the first configuration information further includes configuration information related to the server;
the controller 620 is further configured to generate a second container group description file for the server based on the task description file, and send the second container group description file to the manager 610, where the second container group description file includes third configuration information for the server; and
the manager 610 is further configured to send the received second container group description file to the server, so that the server creates a container group based on the second container group description file, and executes the federated learning task by using the created container group.

In an implementation, that the controller 620 respectively generates first container group description files for the plurality of service party devices includes:
for any service party device, determining, from the task description file, an interaction device that interacts with the service party device in the federated learning task, and second configuration information for the service party device; and
generating a first container group description file for the service party device based on the determined interaction device and the determined second configuration information for the service party device.

In an implementation, that the controller 620 generates a first container group description file for the service party device includes:
setting a restart field in the first container group description file to “Always”, where the restart field is used to indicate whether to perform a container group restart operation when a container group restart condition is met.

In an implementation, that the controller 620 generates a second container group description file for the server includes:
determining, from the task description file, an interaction device that interacts with the server in the federated learning task, and the third configuration information for the server; and
generating the second container group description file based on the determined interaction device and the determined third configuration information for the server.

In an implementation, that the controller 620 generates the second container group description file includes:
setting a restart field in the second container group description file to “Never”, where the restart field is used to indicate whether to perform a container group restart operation when a container group restart condition is met.

In an implementation, the configuration information includes executable file information and image file information; executable file information in the third configuration information is different from executable file information in the second configuration information; and image file information in the third configuration information is the same as or different from image file information in the second configuration information.

In an implementation, the manager 610 is further configured to receive a container group running status sent by the server, and send the container group running status of the server to the controller 620;
the controller 620 is further configured to obtain a container running status of the server from the manager 610, and determine, based on the container running status of the server, whether the federated learning task is completed; and send a deletion message to the manager 610 when determining that the federated learning task is completed, where the deletion message is used to indicate to delete the container groups that are in the plurality of service party devices and that are used to run the federated learning task; and
the manager 610 is further configured to: when receiving the deletion message, delete, by communicating with the plurality of service party devices, the container groups that are in the plurality of service party devices and that are used to run the federated learning task.

In a running process of the container groups in the server and the plurality of service party devices, running statuses of the container groups in the server and the plurality of service party devices are fed back to the container management platform. Therefore, the manager 610 in the container management platform can receive the running status of the container group Pod in the server, and receive running statuses of the Pods in the plurality of service party devices. The controller 620 can query the received Pod running status from the manager 610.

The controller 620 can determine, based on the Pod running status of the server, whether the federated learning task is completed; and when determining that the federated learning task is completed, send a first deletion message to the manager 610. The first deletion message indicates to delete the container groups that are in the plurality of service party devices and that are used to run the federated learning task. When receiving the first deletion message sent by the controller 620, the manager 610 can delete, by communicating with the plurality of service party devices, the container groups that are in the plurality of service party devices and that are used to run the federated learning task.

For example, when determining that execution of the federated learning task is completed, the server exits the corresponding container group, and sends a Pod running status indicating that the container group in the server is successfully exited to the manager 610 in the container management platform.

When determining that the Pod running status sent by the server indicates that the container group in the server is successfully exited, the manager 610 determines that the federated learning task is completed. In this case, the manager 610 can send a second deletion message to the plurality of service party devices. The second deletion message is used to delete the container groups that are in the service party devices and that run the federated learning task. The first deletion message and the second deletion message can carry a name of the federated learning task.

When receiving the second deletion message that is sent by the manager 610 in the container management platform and that indicates to delete the container group, any service party device can delete a corresponding container group. In this way, the container group running in the service party device can be ended.

FIG. 7 is a schematic block diagram of an apparatus for deploying a federated learning task based on a container according to an embodiment. In this embodiment, a federated learning task is deployed to a plurality of service party devices by using a container management platform, and the federated learning task is executed by using the plurality of service party devices. This apparatus embodiment corresponds to the method embodiment shown in FIG. 2. The apparatus 700 is deployed in any service party device and includes:
a first receiving module 710, configured to receive a first container group description file sent by the container management platform, where the first container group description file includes second configuration information for the service party device, the first container group description file is generated based on a task description file for the federated learning task, and the task description file includes the plurality of service party devices and first configuration information; and
a first execution module 720, configured to create a container group based on the first container group description file, and run the created container group to execute the federated learning task.

In an implementation, the first execution module 720 is specifically configured to:
obtain an image file for the federated learning task; and
run the image file for the federated learning task in the created container group based on the second configuration information, and interact with an interaction device indicated in the first container group description file, to execute the federated learning task.

In an implementation, the apparatus 700 further includes:
a deletion module (not shown in the figure), configured to receive a deletion message that is sent by the container management platform and that indicates to delete the container group, and delete the container group.

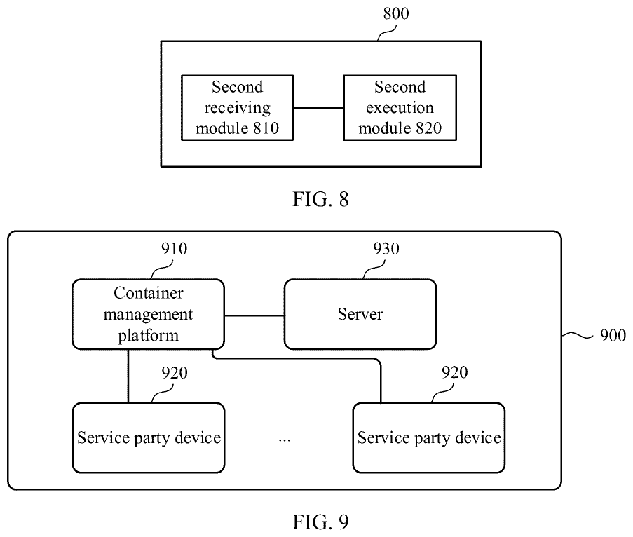

FIG. 8 is a schematic diagram of a structure of another apparatus for deploying a federated learning task based on a container according to an embodiment. In this embodiment, a federated learning task is deployed to a server and a plurality of service party devices by using a container management platform, and the federated learning task is executed by using the server and the plurality of service party devices. This apparatus embodiment corresponds to the method embodiment shown in FIG. 2. The apparatus 800 is deployed in the server and includes:
a second receiving module 810, configured to receive a second container group description file sent by the container management platform, where the second container group description file includes third configuration information for the server, the second container group description file is generated based on a task description file for the federated learning task, and the task description file includes the server, the plurality of service party devices, and first configuration information; and
a second execution module 820, configured to create a container group based on the second container group description file, and run the created container group to execute the federated learning task.

In an implementation, the second execution module 820 is specifically configured to:
obtain an image file for the federated learning task; and
run the image file for the federated learning task in the created container group based on the third configuration information, and interact with an interaction device indicated in the second container group description file, to execute the federated learning task.

In an implementation, the apparatus 800 further includes:
an exit module (not shown in the figure), configured to: when determining that execution of the federated learning task is completed, exit the container group, and send a running status indicating that the container group in the server is successfully exited to the container management platform.

The apparatus embodiments correspond to the method embodiments. For specific descriptions, references can be made to the descriptions in the method embodiments. Details are omitted here for simplicity. The apparatus embodiments are obtained based on the corresponding method embodiments, and have the same technical effects as the corresponding method embodiments. For specific descriptions, references can be made to the corresponding method embodiments.

FIG. 9 is a schematic block diagram of a system for deploying a federated learning task based on a container according to an embodiment. The system 900 includes a container management platform 910 and a plurality of service party devices 920. The system 900 deploys a federated learning task to the plurality of service party devices 920 by using the container management platform 910, and the federated learning task is executed by using the plurality of service party devices 920.

The container management platform 910 is configured to receive a task description file for the federated learning task, where the task description file includes the plurality of service party devices 920 and first configuration information; respectively generate first container group description files for the plurality of service party devices 920 based on the task description file, where the first container group description files respectively include second configuration information for the corresponding service party devices 920; and respectively send the plurality of generated first container group description files to the corresponding service party devices 920.

Any service party device 920 is configured to receive the first container group description file sent by the container management platform 910, create a container group based on the first container group description file, and run the created container group to execute the federated learning task.

In an implementation, the system 900 further includes a server 930. The federated learning task is executed by using the server 930 and the plurality of service party devices 920. The container management platform 910 is configured to deploy the federated learning task to the server 930 and the plurality of service party devices 920. The task description file further includes the server 930. The first configuration information further includes configuration information related to the server 930.

The container management platform 910 is further configured to: after receiving the task description file for the federated learning task, generate a second container group description file for the server 930 based on the task description file, and send the generated second container group description file to the server 930. The second container group description file includes third configuration information for the server 930.

The server 930 is configured to receive the second container group description file sent by the container management platform 910, create a container group based on the second container group description file, and run the created container group to execute the first federated learning task.

The system embodiments correspond to the method embodiments. For specific descriptions, references can be made to the descriptions in the method embodiments. Details are omitted here for simplicity. The system embodiments are obtained based on the corresponding method embodiments, and have the same technical effects as the corresponding method embodiments. For specific descriptions, references can be made to the corresponding method embodiments.

An embodiment of this specification further provides a computer-readable storage medium. The computer-readable storage medium stores a computer program. When the computer program is executed in a computer, the computer is enabled to perform the method in any one of FIG. 1 to FIG. 5.

An embodiment of this specification further provides a computing device, including a memory and a processor. The memory stores executable code. When the processor executes the executable code, the method in any one of FIG. 1 to FIG. 5 is implemented.

The embodiments of this specification are described in a progressive manner. For the same or similar parts of the embodiments, mutual references can be made between the embodiments. Each embodiment focuses on a difference from other embodiments. In particular, the embodiments of the storage medium and the computing device are basically similar to the method embodiments, and therefore are described briefly. For related parts, references can be made to some descriptions in the method embodiments.

A person skilled in the art should be aware that in the foregoing one or more examples, functions described in the embodiments of this specification can be implemented by hardware, software, firmware, or any combination thereof. When being implemented by software, these functions can be stored in a computer-readable medium or transmitted as one or more instructions or code on a computer-readable medium.

The objectives, technical solutions, and beneficial effects of the embodiments of this specification are further described in detail in the specific implementations described above. It should be understood that the foregoing descriptions are merely specific implementations of the embodiments of this specification, and are not intended to limit the protection scope of this specification. Any modification, equivalent replacement, improvement, or the like made based on the technical solutions of this specification shall fall within the protection scope of this specification.

1. A method for deploying a federated learning task based on a container, wherein a federated learning task is deployed to a plurality of service party devices by using a container management platform, the federated learning task is executed by using the plurality of service party devices, and the method is performed by using the container management platform and comprises:
receiving a task description file for the federated learning task, wherein the task description file comprises the plurality of service party devices and first configuration information;
respectively generating first container group description files for the plurality of service party devices based on the task description file, wherein the first container group description files respectively comprise second configuration information for the corresponding service party devices; and
respectively sending the plurality of generated first container group description files to the corresponding service party devices, so that the plurality of service party devices create container groups based on the respective first container group description files, and execute the federated learning task by using the created container groups.

2. The method according to claim 1, wherein the step of receiving a task description file for the federated learning task comprises:
receiving the task description file obtained based on an input operation performed by a user.

3. The method according to claim 1, wherein the federated learning task is executed by using a server and the plurality of service party devices; the container management platform is configured to deploy the federated learning task to the server and the plurality of service party devices; the task description file further comprises the server, and the first configuration information further comprises configuration information related to the server; and after the receiving a task description file for the federated learning task, the method further comprises:
generating a second container group description file for the server based on the task description file, wherein the second container group description file comprises third configuration information for the server; and
sending the generated second container group description file to the server, so that the server creates a container group based on the second container group description file, and executes the federated learning task by using the created container group.

4. The method according to claim 1, wherein the step of respectively generating first container group description files for the plurality of service party devices comprises:
for any service party device, determining, from the task description file, an interaction device that interacts with the service party device in the federated learning task, and second configuration information for the service party device; and
generating a first container group description file for the service party device based on the determined interaction device and the determined second configuration information for the service party device.

5. The method according to claim 4, wherein the step of generating a first container group description file for the service party device comprises:
setting a restart field in the first container group description file to “Always”, wherein the restart field is used to indicate whether to perform a container group restart operation upon determining that a container group restart condition is met.

6. The method according to claim 3, wherein the step of generating a second container group description file for the server comprises:
determining, from the task description file, an interaction device that interacts with the server in the federated learning task, and the third configuration information for the server; and
generating the second container group description file based on the determined interaction device and the determined third configuration information for the server.

7. The method according to claim 6, wherein the step of generating the second container group description file comprises:
setting a restart field in the second container group description file to “Never”, wherein the restart field is used to indicate whether to perform a container group restart operation upon determining that a container group restart condition is met.

8. The method according to claim 3, wherein the configuration information comprises executable file information and image file information; executable file information in the third configuration information is different from executable file information in the second configuration information; and image file information in the third configuration information is the same as or different from image file information in the second configuration information.

9. The method according to claim 3, after the respectively sending the plurality of generated container group description files to the corresponding server and service party devices, further comprising:
obtaining a container group running status of the server;
determining, based on the container group running status of the server, whether the federated learning task is completed; and
upon determining that the federated learning task is completed, deleting, by communicating with the plurality of service party devices, the container groups that are in the plurality of service party devices and that are used to run the federated learning task.

10. A method for deploying a federated learning task based on a container, wherein a federated learning task is deployed to a plurality of service party devices by using a container management platform, the federated learning task is executed by using the plurality of service party devices, and the method is performed by using any service party device and comprises:
receiving a first container group description file sent by the container management platform, wherein the first container group description file comprises second configuration information for the service party device, the first container group description file is generated based on a task description file for the federated learning task, and the task description file comprises the plurality of service party devices and first configuration information; and
creating a container group based on the first container group description file, and running the created container group to execute the federated learning task.

11. The method according to claim 10, wherein the step of running the created container group comprises:
obtaining an image file for the federated learning task; and
running the image file for the federated learning task in the created container group based on the second configuration information, and interacting with an interaction device indicated in the first container group description file, to execute the federated learning task.

12. The method according to claim 10, further comprising:
receiving a deletion message that is sent by the container management platform and that indicates to delete the container group, and deleting the container group.

13. A method for deploying a federated learning task based on a container, wherein a federated learning task is deployed to a server and a plurality of service party devices by using a container management platform, the federated learning task is executed by using the server and the plurality of service party devices, and the method is performed by using the server and comprises:
receiving a second container group description file sent by the container management platform, wherein the second container group description file comprises third configuration information for the server, the second container group description file is generated based on a task description file for the federated learning task, and the task description file comprises the server, the plurality of service party devices, and first configuration information; and
creating a container group based on the second container group description file, and running the created container group to execute the federated learning task.

14. The method according to claim 13, wherein the step of running the created container group comprises:
obtaining an image file for the federated learning task; and
running the image file for the federated learning task in the created container group based on the third configuration information, and interacting with an interaction device indicated in the second container group description file, to execute the federated learning task.

15. The method according to claim 13, further comprising:
upon determining that execution of the federated learning task is completed, exiting the container group, and sending a running status indicating that the container group in the server is successfully exited to the container management platform.

16. (canceled)

17. A container management platform, configured to deploy a federated learning task to a plurality of service party devices, wherein the federated learning task is executed by using the plurality of service party devices, and the container management platform comprises a manager and a controller;
the manager is configured to receive a task description file for the federated learning task, and send the task description file to the controller, wherein the task description file comprises the plurality of service party devices and first configuration information;
the controller is configured to respectively generate first container group description files for the plurality of service party devices based on the task description file, and send the first container group description files to the manager, wherein the first container group description files comprise second configuration information for the corresponding service party devices; and
the manager is configured to respectively send the plurality of received first container group description files to the corresponding service party devices, so that the plurality of service party devices create container groups based on the respective first container group description files, and execute the federated learning task by using the created container groups.

18. The container management platform according to claim 17, wherein the federated learning task is executed by using a server and the plurality of service party devices; the container management platform is configured to deploy the federated learning task to the server and the plurality of service party devices; and the task description file further comprises the server, and the first configuration information further comprises configuration information related to the server;
the controller is further configured to generate a second container group description file for the server based on the task description file, and send the second container group description file to the manager, wherein the second container group description file comprises third configuration information for the server; and
the manager is further configured to send the received second container group description file to the server, so that the server creates a container group based on the second container group description file, and executes the federated learning task by using the created container group.

19. The container management platform according to claim 18, wherein the manager is further configured to receive a container group running status sent by the server;
the controller is further configured to obtain a container group running status of the server from the manager, and determine, based on the container running status of the server, whether the federated learning task is completed; and send a deletion message to the manager upon determining that the federated learning task is completed, wherein the deletion message is used to indicate to delete the container groups that are in the plurality of service party devices and that are used to run the federated learning task; and
the manager is further configured to: in response to receiving the deletion message, delete, by communicating with the plurality of service party devices, the container groups that are in the plurality of service party devices and that are used to run the federated learning task.

20. (canceled)

21. (canceled)

22. A system for deploying a federated learning task based on a container, comprising a container management platform and a plurality of service party devices, wherein the system deploys a federated learning task to the plurality of service party devices by using the container management platform, and the federated learning task is executed by using the plurality of service party devices;
the container management platform is configured to receive a task description file for the federated learning task, wherein the task description file comprises the plurality of service party devices and first configuration information; respectively generate first container group description files for the plurality of service party devices based on the task description file, wherein the first container group description files respectively comprise second configuration information for the corresponding service party devices; and respectively send the plurality of generated first container group description files to the corresponding service party devices; and
any service party device is configured to receive the first container group description file sent by the container management platform, create a container group based on the first container group description file, and run the created container group to execute the federated learning task.

23. (canceled)

24. (canceled)
